(19) United States
(12) Patent Application Publication
(10) Pub. No.: US 2010/0053084 A1
(43) Pub. Date: Mar. 4, 2010

(54) COLLAPSIBLE MOUSE WITH PINCH-RISK SOLUTION

(75) Inventors: Monique Chatterjee, Seattle, WA (US); Eric J. Wahl, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/198,907

(22) Filed: Aug. 27, 2008

(51) Int. Cl. G06F 3/033

(52) U.S. Cl. 345/163

(57) ABSTRACT

Architecture for a collapsible mouse having a hinge with an anti-pinch component. For example, the anti-pinch component can be a sheath that covers the hinge area between a main body portion and a tail portion of the collapsible mouse. The anti-pinch component can also include a hinge having hinge portions respectively connected to the main body portion and the tail portion where each hinge portion has a surface continuous with surfaces of the main body portion and the tail portion, to not permit a gap into which pinching can occur. The anti-pinch component can also include a slot formed between the surfaces of the main body portion and the tail portion. The slot cooperates with a recessed hinge so that the surfaces of the main body portion do not come into contact at any time, thus precluding pinching.

### BACKGROUND

A computer mouse is an input component commonly used with a graphical user interface. The mouse is moved over a flat surface such as a table by a user's hand. Electrical signals are generated corresponding to the mouse movement and sent to the computer. This movement is translated into movement of a cursor on a computer monitor. Operations can be performed by clicking a number of mouse buttons, for example clicking an on-screen icon to execute a software program.

In working on a computer for extended periods of time, a computer mouse that fits comfortably in the hand can be a consideration. However, with the rise of remote wireless computing, there is value in having a small, portable mouse. A collapsible mouse has been found to satisfy these conditions.

The collapsible mouse can be folded between a full-sized position and a smaller, folded position, thereby reducing size by nearly a half. The collapsible mouse thus enables a user to select between the comfort and accessibility of a full-sized mouse and the portability of a notebook mouse.

However, the collapsible mouse can include a hinge that is in contact with a user's palm during folding and operation. This can pose a pinch risk to the user in the event that loose skin on the user's hand is accidentally caught in the hinge or surrounding areas.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed herein for reducing or avoiding the pinch risk surrounding the hinge of a collapsible mouse. The collapsible mouse includes a first body portion and a second body portion, and a hinge for foldably connecting the first and second body portions. An anti-pinch component substantially prevents pinching along the hinge between the first and second body portions. The anti-pinch component can include a sheath for covering the hinge. The anti-pinch component can alternatively include hinge portions continuous with the surfaces of the first and second body portions. The anti-pinch component can also include a slot that separates the first and second body portions, as will be disclosed in detail hereinbelow.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 is a side view illustrating a collapsible mouse having a hinge with an anti-pinch component.

FIG. 2 is an oblique view illustrating the collapsible mouse having the hinge with the anti-pinch component in accordance with the embodiment of FIG. 1.

FIG. 3 is a side sectional view illustrating the collapsible mouse having the hinge with the anti-pinch component in accordance with the embodiment of FIG. 1 and FIG. 2.

FIG. 4 is an oblique view illustrating an alternative embodiment of a collapsible mouse having a hinge with an anti-pinch component.

FIG. 5 is an oblique view illustrating a further alternative embodiment of a collapsible mouse having a hinge with an anti-pinch component.

FIG. 6 is a side view illustrating the collapsible mouse having the hinge with the anti-pinch component in accordance with the embodiment of FIG. 5.

FIG. 7 is an oblique view illustrating another alternative embodiment of a collapsible mouse having a hinge with an anti-pinch component.

FIG. 8 is a side view illustrating the collapsible mouse having the hinge with the anti-pinch component in accordance with the embodiment of FIG. 7.

FIG. 9 is a side sectional view illustrating internal mouse components as can be used with the aforementioned embodiments.

### DETAILED DESCRIPTION

The disclosed architecture relates to a collapsible mouse having a hinge with an anti-pinch component. For example, the anti-pinch component can be a sheath that covers the hinge area between a main body portion and a tail portion of the collapsible mouse. The anti-pinch component can also include a hinge having hinge portions respectively connected to the main body portion and the tail portion. Each hinge portion has a surface continuous with surfaces of the main body portion and the tail portion, to not permit a gap into which pinching can occur. The anti-pinch component can also include a slot formed between the surfaces of the main body portion and the tail portion. The slot cooperates with a recessed hinge so that the surfaces of the main body portion do not come into contact at any time, thus precluding pinching.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

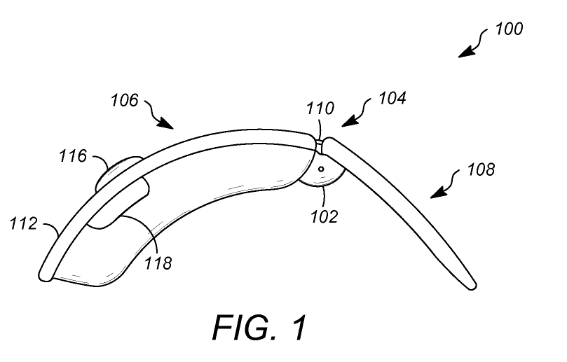

FIG. 1 is a side view illustrating a collapsible mouse 100 having a hinge 102 with an anti-pinch component 104. The collapsible mouse 100 includes a first body portion 106 and a second body portion 108. As used herein, the first body portion 106 can be a main body portion and the second body portion 108 can be a tail portion. However, it is to be appreciated that these components and the functions associated therewith can be configured in any suitable manner.

The hinge 102 is configured for foldably connecting the first body portion 106 and the second body portion 108. The hinge 102 can include hinge portions respectively attached to the first body portion 106 and the second body portion 108, to allow pivotal motion about a pivot axis. However, any suitable hinge structure could be contemplated that would allow a collapsible mouse with the foldably connected first body portion 106 and second body portion 108.

The anti-pinch component 104 substantially prevents pinching along the hinge 102 between the first body portion 106 and the second body portion 108. The anti-pinch component 104 substantially fills a gap between the first body portion 106 and the second body portion 108, and thereby does not allow a user's skin or other objects to enter the area around the hinge 102 and thus get pinched. Here, the anti-pinch component 104 includes a sheath 110.

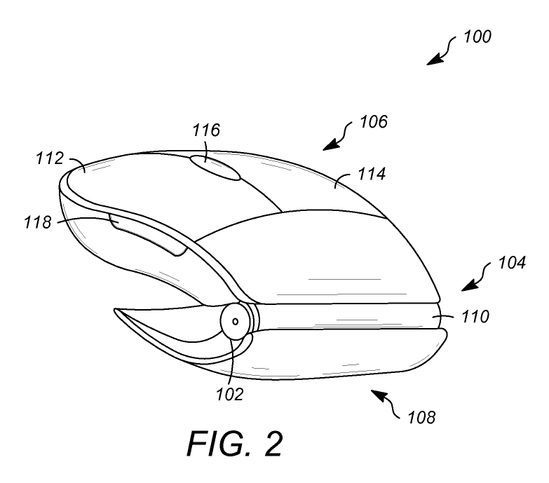

FIG. 2 is an oblique view illustrating the collapsible mouse 100 having the hinge 102 with the anti-pinch component 104 in accordance with the embodiment of FIG. 1. While FIG. 1 depicts the collapsible mouse 100 in an open, extended, full-sized position, FIG. 2 depicts the collapsible mouse 100 in a closed, smaller, folded position.

As shown in FIG. 1 and FIG. 2, the anti-pinch component 104 can include the sheath 110 that extends between the first body portion 106 (e.g., the main body portion) and the second body portion 108 (e.g., the tail portion). The sheath 110 extends substantially over the axial length of the hinge 102 for substantially covering the hinge 102 when the mouse 100 is in the folded position and in the extended position, to thereby preclude pinching.

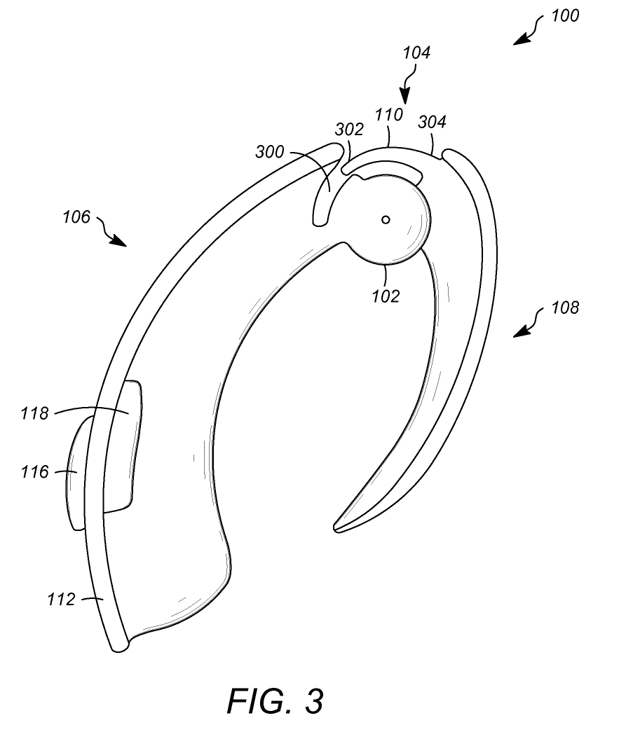

FIG. 3 is a side sectional view illustrating the collapsible mouse 100 having the hinge 102 with the anti-pinch component 104 in accordance with the embodiments of FIG. 1 and FIG. 2. In particular, FIG. 3 illustrates the structure and operation of the sheath 110 as used to prevent pinching.

As illustrated in FIG. 3, the sheath 110 can be a rigid member having a substantially circular configuration, for example, in the shape of a hollow cylinder and having a circular cross section. The sheath 110 can be rotatably received within a clearance volume 300. In this way, the sheath 110 can be substantially stowed within the clearance volume 300 when the collapsible mouse 100 is in the open, extended position. The sheath 110 can be of sufficient length so that a first end 302 is received within the clearance volume 300 when the collapsible mouse 100 is in the closed, folded position.

The sheath 110 also includes a second end 304 that is fixed opposite the clearance volume 300. As illustrated, the clearance volume 300 can be formed within the first body portion 106 (e.g., the main body portion) and the second end 304 can be attached to the second body portion 108 (e.g., the tail portion). However, it is to be appreciated that the clearance volume 300 can alternatively be formed in the second body portion 108 (e.g., the tail portion) and the second end 304 can be affixed to the first body portion 106 (e.g., the main body portion). In either instance, the sheath 110 is configured for rotatably moving into and out of either the main body portion or the tail portion when the collapsible mouse 100 is in the fully extended position.

Further to the above, it is to be appreciated the sheath 110 can alternatively be formed as a flexible member that flexes when the hinge 102 pivots between the extended position and the folded position. In the embodiment depicted in FIG. 2, the sheath 110 can fixed to one or both of the first body portion 106 and the second body portion 108. As a flexible implementation, the sheath 110 can fold accordion-style when the collapsible mouse 100 is in the extended position. The sheath 110 can fold inwardly toward the hinge 102 or outwardly away from the hinge 102.

Alternatively, the sheath 110 can be a telescoping member. A number of interacting components can extend from either the first body portion 106 or the second body portion 108 when the collapsible mouse 100 is in the folded position.

In yet another alternative embodiment, the outer surface of the second end 304 can gradually transition into the surface of the second body portion 108 so that when the mouse 100 is opened, the pinch area defined between the first body portion 106, the second body portion 108, and the hinge is further inhibited from pinching the user.

As shown in the embodiment of FIG. 1, FIG. 2, and FIG. 3, the collapsible mouse 100 can include buttons typically used with a conventional mouse. The collapsible mouse 100 can includes a left mouse button 112 and a right mouse button 114. A central scrolling wheel 116 can also be included. Side buttons can also be included, such as a left side button 118. Though not specifically illustrated, it is to be appreciated that a right side button can also be included. These buttons 112, 114, 116, and 118 can also be included in the other embodiments, as will be described hereinbelow.

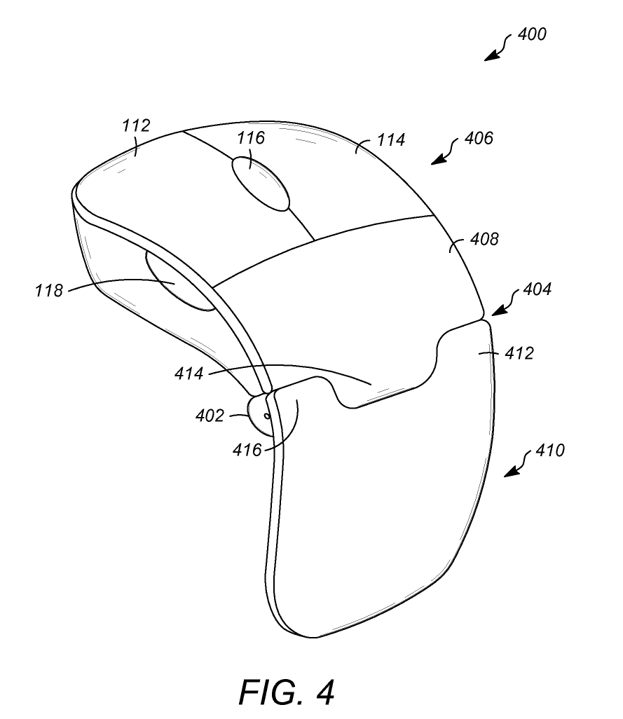

FIG. 4 is an oblique view illustrating an alternative embodiment of a collapsible mouse 400 having a hinge 402 with an anti-pinch structure 404. The collapsible mouse 400 includes a main body portion 406 having a main body portion surface 408. A tail portion 410 is included having a tail portion surface 412. The hinge 402 foldably connects the main body portion 406 to the tail portion 410, for pivoting between an extended position and a folded position. The anti-pinch structure 404 prevents pinching between the main body portion 406 and the tail portion 410 by way of the style of the hinge 402 which aligns with the main body portion surface 408 and the tail portion surface 412.

As illustrated in FIG. 4, the hinge 402 comprises a first hinge portion 414 connected to the main body portion 406 (similar to earlier referenced first body portion). The hinge 402 also includes a second hinge portion 416 connected to the tail portion 410 (similar to earlier referenced second body portion). The first hinge portion 414 and the second hinge portion 416 can be formed integrally with the main body portion 406 and tail portion 410, respectively. In this way, the first hinge portion 414 is pivotally connected to the second hinge portion 416.

As illustrated in FIG. 4, the first hinge portion 414 is a single hinge portion while the second hinge portion 416 is a bifurcated, two-piece structure into which the first hinge portion 414 is nested. However, it is to be appreciated that the structure of these hinge portions (414 and 416) can, alternatively, be reversed, or alternatively, that the hinge 402 can be formed of any number of hinge portions or other nesting structures.

As depicted in FIG. 4, the anti-pinch structure 404 is formed by the hinge portions (414 and 416), which together define a hinge surface. The hinge surface defined by the surfaces of the hinge portions (414 and 416) is formed continuously with the main body portion surface 408 and the tail portion surface 412. In other words, the hinge surface and the main body and tail portion surfaces (408 and 412) define a smooth, unbroken surface without gaps or other discontinuities. In this way, foldable motion is enabled between an open position and a closed position without a pinch gap between the main body portion 406 and tail portion 410.

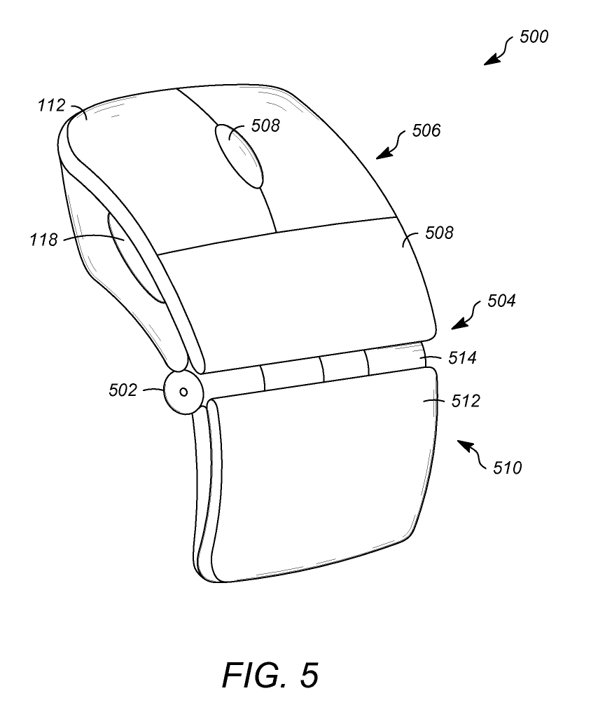

FIG. 5 is an oblique view illustrating a further alternative embodiment of a collapsible mouse 500 having a hinge 502 with an anti-pinch structure 504. The collapsible mouse 500 includes a main body portion 506 having a main body portion surface 508. A tail portion 510 is included having a tail portion surface 512. The hinge 502 foldably connects the main body portion 506 to the tail portion 510, for pivoting between an extended position and a folded position. The anti-pinch structure 504 prevents pinching between the main body portion 506 and the tail portion 510.

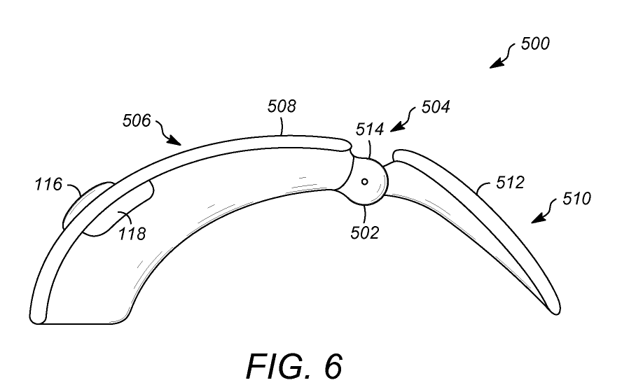

As illustrated in FIG. 5, and also in the side view of FIG. 6, the hinge 502 includes a hinge surface 514 that is recessed from the main body portion surface 508 and the tail portion surface 512. The anti-pinch structure 504 is defined by the separation between the recessed hinge surface 514 and the surfaces (508 and 512) of the main body portion 506 and tail portion 510 that prevents pinch. The anti-pinch structure 504 thus includes a slot that separates the main body portion surface 508 and the tail portion surface 512, which thereby precludes pinching. When unfolded from the closed position to the extended position, the slot remains sufficiently wide so that the user's skin or other objects cannot become pinched therebetween.

As illustrated in FIG. 5 and FIG. 6, the hinge 502 comprises hinge portions respectively connected to the main body portion 506 (similar to earlier referenced first body portion) and the tail portion 510 (similar to earlier referenced second body portion). The hinge portions can be formed integrally with the main body portion 506 and tail portion 510, respectively, so as to define a pivotal connection therebetween. The hinge portions can be any sort of nested structure and can be formed of any number of hinge portions or other nesting structures respectively attached to either of the body portions.

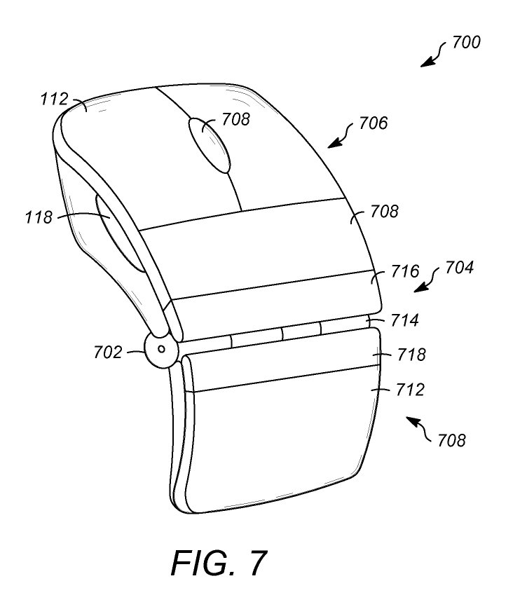

FIG. 7 is an oblique view illustrating another alternative embodiment of a collapsible mouse 700 having a hinge 702 with an anti-pinch structure 704. The collapsible mouse 700 includes a main body portion 706 having a main body portion surface 708. A tail portion 710 is included having a tail portion surface 712. The hinge 702 foldably connects the main body portion 706 to the tail portion 708, for pivoting between an extended position and a folded position. The anti-pinch structure 704 prevents pinching between the main body portion 706 and the tail portion 710 by using a soft flexible material.

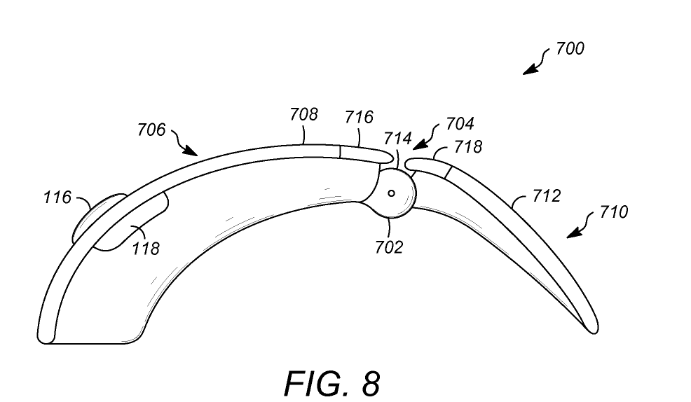

As illustrated in FIG. 7, and also in the side view of FIG. 8, the hinge 702 includes a hinge surface 714 that is recessed from main body portion surface 708 and the tail portion surface 712. The anti-pinch structure 704 is defined by a first bumper 716 formed on the main body portion 706 and aligned with the main body portion surface 708, and a second bumper 718 formed on the tail portion 708 and aligned with the tail portion surface 712. The first and second bumpers (716 and 718) are formed on opposing edge portions of the main body portion surface 708 and the tail portion surface 712. The first and second bumpers (716 and 718) can be formed of a soft, flexible material such as foam rubber and disposed along the open areas where pinch risk can occur.

In the event a user's loose skin or other object is moved into the pinch area defined by the surfaces (708 and 712), and the hinge 702, the bumpers (716 and 718) will flex to avoid pinching when the mouse 700 is opened. The bumpers (716 and 718) can define edges of the surfaces (708 and 712) adjoining the slot, or the bumpers (716 and 718) can fill the area between the surfaces (708 and 712), to reduce or encompass the area of the slot. The bumpers (716 and 718) can be formed of any suitable flexible and durable material. Alternatively, the entire main body portion surface 708 and tail portion surface 712 can be formed of the flexible material. Additionally, the bumpers (716 and 718) can be formed of a single flexible piece that fills the area between the surfaces (708 and 712) and compresses when the mouse 700 is opened such that the material compresses to push a portion of the material outwardly from the hinge area, thereby filling the pinch area so as to prevent skin or other material from entering the pinch area when in the opened position.

As illustrated in FIG. 7, the hinge 702 comprises hinge portions respectively connected to the main body portion 706 (similar to the earlier referenced first body portion) and the tail portion 710 (similar to the earlier referenced second body portion). The hinge portions can be formed integrally with the main body portion 706 and tail portion 708, respectively, so as to define a pivotal connection therebetween. The hinge portions can be any sort of nested structure and can be formed of any number of hinge portions or other nesting structures respectively attached to either of the body portions.

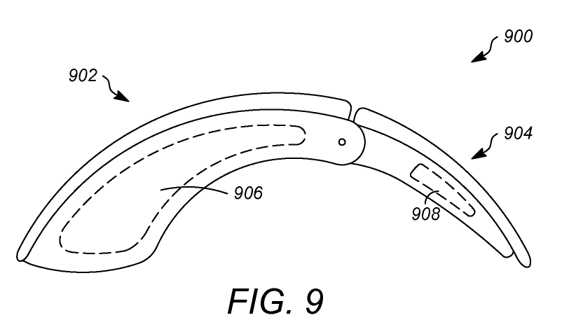

FIG. 9 is a side sectional view illustrating internal mouse components as can be used with the aforementioned embodiments. A collapsible mouse 900 is shown having a first body portion 902 (e.g., a main body portion) and a second body portion 904 (e.g., a tail portion). A tracking component 906 (e.g., an optical tracking component) is included for tracking movement of the collapsible mouse 900 relative to a tracking surface.

It should be appreciated that any other type of tracking component can alternatively be used, such as a “track ball” or other type of mechanical or electronic tracking structure. Additionally, as depicted, the tracking component 906 is shown in the first body portion 902, though it can also alternatively be placed in the second body portion 904.

FIG. 9 also illustrates a communication component 908 (e.g., a wireless communications component) for sending signals to and receiving signals from a computer. It is to be appreciated a wired communications component or any other suitable communications interface can also be alternatively employed. Additionally, as depicted, the communications component 908 is shown in the second body portion 904, though it can also alternatively be placed in the first body portion 902.

As shown in the aforementioned embodiments, the collapsible mouse and the first and second body portions composed thereof all have an arcuate configuration when in the extended position. The first and second body portions are in abutment when in the folded position, for reducing a device footprint. It is to be appreciated that a collapsible mouse of any suitable shape or configuration can also be contemplated as being within the scope of the hereindisclosed embodiments.

The aforementioned disclosure relates to several embodiments of a collapsible mouse for use as an interface component with a personal computer. With the “sheath” style anti-pinch component, a thin cover is placed inside the hinge area that prevents fingers or loose skin from getting caught between the two halves of the collapsible mouse. The sheath is exposed when the mouse is closed. The sheath can be attached to the tail portion of the mouse and rotates into the main body portion in the front of the mouse as the collapsible mouse arc is opened.

With an “extended hinge” style anti-pinch component, a hinge is interlocked in a way that does not allow for a pinch area. The full hinge rotates around itself and extends to the outer edges of the mouse. It leaves no open area for someone to catch their finger or loose skin. With a “slotted” style anti-pinch component, a slot is formed on the top surface of the two top case parts so that it is more difficult to accidentally catch any loose skin in the hinge area.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A collapsible mouse, comprising:
a first body portion and a second body portion;
a hinge for foldably connecting the first and second body portions; and
an anti-pinch component for substantially preventing pinching along the hinge between the first and second body portions.

2. The collapsible mouse of claim 1, wherein the anti-pinch component further comprises a sheath for substantially covering the hinge between the first and second body portions.

3. The collapsible mouse of claim 1, wherein the anti-pinch component comprises a hinge surface of the hinge formed continuously with first and second body portion surfaces that enable foldable motion of the first and second body portions without a pinch gap.

4. The collapsible mouse of claim 1, wherein the anti-pinch component comprises a hinge surface recessed from first and second body portion surfaces for forming a slot separating the first and second body portion surfaces that precludes pinching.

5. The collapsible mouse of claim 1, wherein the hinge comprises a first hinge portion connected to the first body portion and a second hinge portion connected to the second body portion, the first hinge portion pivotally connected to the second hinge portion.

6. The collapsible mouse of claim 5, wherein the first and second hinge portions are respectively formed integrally with the first and second body portions.

7. The collapsible mouse of claim 1, wherein the first and second body portions have an arcuate configuration when in an extended position.

8. The collapsible mouse of claim 1, wherein the first and second body portions are in abutment when in a folded position, for reducing a device footprint.

9. The collapsible mouse of claim 1, further comprising a tracking component for tracking movement of the mouse relative to a tracking surface and a communications component for sending signals to and receiving signals from a computer.

10. The collapsible mouse of claim 1, further comprising first and second bumpers formed respectively on opposing edge portions of the first and second body portions for flexing when the mouse is opened to preclude pinching.

11. A collapsible mouse, comprising:
a main body portion foldably connected to a tail portion;
a hinge for foldably connecting the main body portion to the tail portion and for pivoting between an extended position and a folded position; and
a sheath extending between the main body portion and the tail portion and over the hinge for covering the hinge when in the folded position and in the extended position.

12. The collapsible mouse of claim 11, wherein the sheath is rotatably received within a clearance volume on one of the main body portion or the tail portion when in the extended position.

13. The collapsible mouse of claim 11, wherein the sheath includes an end that is fixed to one of the main body portion or the tail portion.

14. The collapsible mouse of claim 11, wherein the sheath is a rigid member having a substantially circular configuration for rotatably moving into one of the main body portion or the tail portion.

15. The collapsible mouse of claim 11, wherein the sheath is a flexible member that flexes when the hinge pivots between the extended position and the folded position.

16. A collapsible mouse, comprising:
a main body portion having a main body portion surface;
a tail portion having a tail portion surface;
a hinge for foldably connecting the main body portion to the tail portion, for pivoting between an extended position and a folded position; and
an anti-pinch structure for preventing pinching between the main body portion and the tail portion.

17. The collapsible mouse of claim 16, wherein the anti-pinch structure comprises a hinge surface formed continuously with the main body portion surface and the tail portion surface, for enabling foldable motion to an open position without a pinch gap between the main body and tail portions.

18. The collapsible mouse of claim 16, wherein the anti-pinch structure comprises a hinge surface recessed from the main body portion surface and the tail portion surface for forming a slot that separates the main body and tail portion surfaces to preclude pinching when in the extended position.

19. The collapsible mouse of claim 16, wherein the hinge comprises a first hinge portion pivotally connected to a second hinge portion, the first hinge portion is connected to the main body portion and the second hinge portion is connected to the tail portion.

20. The collapsible mouse of claim 19, wherein the first and second hinge portions are respectively formed integrally with the main body portion and the tail portion.
